(19) United States
(12) Patent Application Publication
(10) Pub. No.: US 2020/0368919 A1
(43) Pub. Date: Nov. 26, 2020

(54) Robotic Arm

(71) Applicant: University of Plymouth, Plymouth Devon (GB)

(72) Inventor: Martin Stoelen, Drake Circus, Plymouth (GB)

(21) Appl. No.: 16/646,565

(22) PCT Filed: Sep. 18, 2018
(86) PCT No.: PCT/GB2018/052654

§ 371 Date: Mar. 11, 2020

(30) Foreign Application Priority Data
Sep. 18, 2017 (GB) 1715005.3
Sep. 18, 2017 (GB) 1715006.1
Sep. 18, 2017 (GB) 1715007.9

(51) Int. Cl. B25J 13/08; B25J 9/10; B25J 9/12; B25J 11/00; B25J 5/00; B25J 9/16; A01D 46/30; A01D 46/253; A01D 45/10; G06K 9/00

(52) U.S. Cl. CPC B25J 13/08; B25J 9/1075; B25J 9/12; B25J 11/0045; B25J 5/007; B25J 15/00; A01D 46/30; A01D 46/253; A01D 45/10; G06K 9/00664; B25J 9/1697

(57) ABSTRACT

In general terms, the present invention provides a passively compliant robotic arm having one or more variable stiffness joints controllable by first and second bi-directional actuators that can be independently operated. Each bi-directional actuator may be operable in a first configuration to urge the joint in a first direction, and in a second configuration to urge the joint in a second direction opposite to the first direction. The bi-directional actuators may be operated in a cooperating mode (high torque mode) in which they work in tandem (i.e. both in the first configuration or second configuration) to double the available torque output. The bi-directional actuators may also (or alternatively) be operated in a high stiffness mode (antagonist mode) in which they counter-act each other by operating so that they oppose one another (i.e. one in the first configuration and the other in the second configuration). The high torque mode may be utilised for an initial portion of a movement trajectory, and the antagonist mode for a final portion of the movement trajectory. The relatively high stiffness in the high stiffness/antagonist mode results from the combined effects of the non-linear force-deflection relationship of the first and second resilient members. The resilient members may each comprise an elastic element, tendon or other resilient member that can be stretched (elongated) to increase tension therein and thereby urge the joint to move.

### TECHNICAL FIELD

The present application concerns embodiments of a passively compliant robotic arm, and methods of controlling such a robotic arm.

### BACKGROUND

Passively compliant robotic arms have a relatively low resistance to deflection resulting from an externally applied load. As such, they are known to be particularly suitable for operation in environments shared with humans, where accidental contact between humans and robotic arms may occur.

Stoelen, M. et al have explored some developments in “Co-exploring actuator antagonism and bio-inspired control in a printable robot arm”, International Conference on Simulation of Adaptive Behavior, SAB 2016: From Animals to Animats 14 pp 244-255, 2016. The focus of the present application is improvements to the hardware and control of passively compliant robotic arms to provide fast and precise joint movements, without overly complex control.

### SUMMARY OF THE INVENTION

In general terms, the first and second aspects of the present invention provide a passively compliant robotic arm having one or more variable stiffness joints controllable by first and second bi-directional actuators that can be independently operated. Each bi-directional actuator may be operable in a first configuration to urge the joint in a first direction, and in a second configuration to urge the joint in a second direction opposite to the first direction.

The bi-directional actuators may be operated in a cooperating mode (high torque mode) in which they work in tandem (i.e. both in the first configuration or second configuration) to double the available torque output; this arrangement provides a relatively low joint stiffness and a relatively high passive compliance (i.e. the joint has a relatively low resistance to deflection resulting from an externally applied torque). The bi-directional actuators may also (or alternatively) be operated in a high stiffness mode (antagonist mode) in which they counter-act each other by operating so that they oppose one another (i.e. one in the first configuration and the other in the second configuration); this arrangement provides a relatively high joint stiffness and relatively low passive compliance (i.e. the joint has a relatively high resistance to deflection resulting from an externally applied torque).

The first and second bi-directional actuators each comprise first and second resilient members, an increase in tension in the first resilient member (i.e. operation in the first configuration) causing movement of the joint in a first direction and an increase in tension in the second resilient member (i.e. operation in the second configuration) causing movement of the joint in a second direction opposite to the second direction. The first and second resilient members each have a monotonically increasing non-linear relationship between applied force and resulting elongation.

The relatively high stiffness in the high stiffness/antagonist mode results from the combined effects of the non-linear force-deflection relationship of the first and second resilient members. The resilient members may each comprise an elastic element, tendon or other resilient member that can be stretched (elongated) to increase tension therein and thereby urge the joint to move.

In a first aspect, the present invention provides a robotic arm comprising: a joint permitting movement between a first link and a second link; and first and second bi-directional actuators, each comprising a first resilient member actuatable by an increase in tension to urge the joint to move in a first direction and a second resilient member actuatable by an increase in tension to urge the joint to move in a second direction opposite to the first direction, each of the bi-directional actuators being controllable to increase tension in one of the first and second resilient members while decreasing tension in the other of the first and second resilient members, wherein the first resilient members and second resilient members have a non-linear relationship between applied force and resulting elongation, and comprise a composite material having a generally elastic portion and a relatively stiff portion.

Similarly, the first aspect of the invention provides a method of controlling a robotic arm comprising a joint permitting movement between a first link and a second link, and first and second bi-directional actuators, each of the first and second bi-directional actuators comprising a first resilient member actuatable by an increase in tension to urge the joint to move in a first direction and a second resilient member actuatable by an increase in tension to urge the joint to move in a second direction opposite to the first direction, wherein the first resilient members and second resilient members have a non-linear relationship between applied force and resulting elongation, and comprise a composite material having a generally elastic portion and a relatively stiff portion, the method including the steps of: controlling the first bi-directional actuator to increase tension in one of the first and second resilient members thereof while decreasing tension in the other of the first and second resilient members; and controlling the second bi-directional actuator to increase tension in one of the first and second resilient members thereof while decreasing tension in the other of the first and second resilient members.

In this way, the first and second bi-directional actuators can be independently operated to enable full control of the joint. In particular, the bi-directional actuators may be operated so that they work in tandem or so that they oppose one another. The composite material of the resilient members provides a particularly suitable form for the resilient members because the generally elastic portion enables a high degree of elongation, while the relatively stiff portion provides a limit to the possible elongation. Importantly, the elastic portion also provides inherent damping. Such damping reduces the amplitude of oscillations in the joint resulting from a movement of that joint.

The generally elastic portion may exhibit one or more elastic characteristics, such as an ability to deform (e.g. elongate) under an applied tension and vice versa, and to return to its original shape and size upon removal of the tension. The generally elastic portion may exhibit one or more characteristics of rubber elasticity, such as a cross-linked polymer chain that permits elongation of the generally elastic portion but that provides a restoring force which acts to urge it to its un-elongated configuration upon removal of the applied force.

The relatively stiff portion may also elongate under an applied tension. Preferably, its stiffness (i.e. its resistance to elongation) increases with elongation. Thus, the relatively stiff portion preferably provides an increase in stiffness of the respective resilient member with elongation of the resilient member.

Together the generally elastic portion and relatively stiff portion provide the resilient member with an ability to elongate under an applied tension and return to its original length upon removal of the tension, combined with a relationship between elongation and applied force (tension) in which its stiffness (i.e. its resistance to elongation) increases with elongation of the resilient member.

The resilient member provides the joint with a controllable degree of passive compliance. That is, the overall resistance of the joint to deflection resulting from an externally applied torque can be controlled. The claimed arrangement is therefore considered to be particularly suitable for operation in un-structured or partially un-structured environments with unreliable sensory information.

An example of such an environment is selective robotic harvesting of fruits and vegetables for fresh consumption. In such environments the sensory information is typically fast-changing because of the uncontrolled nature of the environment (e.g. moving targets due to wind, rain etc.) and the inherently noisy nature of the environment (e.g. varying amounts of sunlight).

In preferred embodiments the first and second bi-directional actuators are controllable to operate in a high torque mode in which the first and second bi-directional actuators each provide tension in their respective first resilient members. In this cooperating mode the bi-directional actuators work in tandem to double the available torque output; this arrangement provides a relatively low joint stiffness and a relatively high passive compliance (i.e. the joint has a relatively low resistance to deflection resulting from an externally applied torque).

The first and second bi-directional actuators are also (or alternatively) preferably controllable to operate in an antagonist mode in which the first bi-directional actuator provides tension in its first resilient member while the second bi-directional actuator provides tension in its second resilient member. In this high stiffness mode the bi-directional actuators counter-act each other by operating so that they oppose one another; this arrangement provides a relatively high joint stiffness and relatively low passive compliance (i.e. the joint has a relatively high resistance to deflection resulting from an externally applied torque). The antagonist mode may provide an overall joint stiffness from 0% (maximum passive compliance) to 100% (minimum passive compliance).

The first and second bi-directional actuators may further be controllable to operate on a sliding scale between the high torque mode and the antagonist mode. That is, in moving between the high torque mode and antagonist mode a trade-off is made between torque output and joint stiffness. For example, from the high torque mode, the first bi-directional actuator may reduce the level of tension in its first resilient member while the second bi-directional actuator gradually increases the level of tension in its second resilient member to gradually increase the overall stiffness of the joint, yet not necessarily cause the joint to move. Similarly, in the high torque mode the tension in the second resilient members of the first and/or second bi-directional actuators may also be controlled in order to provide a degree of overall joint stiffness.

This sliding scale operation results from the feature that each of the bi-directional actuators is controllable to increase tension in one of the first and second resilient members while decreasing tension in the other of the first and second resilient members. Moreover, a tension in each of the first and second resilient members can be controlled between a minimum tension and a maximum tension; ideally, each resilient member is always under some tension.

In preferred embodiments the composite material is configured in such a way that, as the resilient member is elongated, the elastic portion initially carries the majority of the load, but as the elongation increases the relatively stiff portion carries a progressively higher proportion of the load to provide an increasing resistance to further elongation.

In preferred embodiments the elastic portion comprises a core of the composite material and the relatively stiff portion comprises an outer surrounding portion. The relatively stiff portion preferably has a configuration that exhibits lateral contraction in response to longitudinal elongation. This arrangement is particularly suitable for providing an initial low resistance to elongation and progressive increase in resistance to elongation as elongation increases. That is, when the resilient member is subjected to an elongating force, the consequential longitudinal elongation of the relatively stiff portion results in a lateral contraction thereof. This lateral contraction is resisted by the elastic portion at the core of the composite material, and it is this resistance and the consequential deformation of the elastic portion that causes the progressive increase in resistance to elongation. As an example of such a configuration, the relatively stiff portion may comprise a spiral of material encasing the elastic portion. Alternatively, the relatively stiff portion may comprise a mesh sheath or other similar structure.

The elastic portion preferably comprises an elastomer, such as a thermoplastic elastomer. The relatively stiff portion preferably comprises a polymer, such as a thermoplastic polymer.

In preferred embodiments the robotic arm comprises a plurality of joints, each joint being controllable by first and second bi-directional actuators according to the invention.

In some embodiments the joint permits the second link to pivot relative to the first link about a pivot axis of the joint located between a first anchor point and a second anchor point of the second link, wherein in each of the first and second bi-directional actuators the first resilient member extends between the first anchor point and the first link and the second resilient member extends between the second anchor point and the first link.

A second aspect of the invention provides a robotic arm comprising: a first link, a second link and a joint permitting the second link to pivot relative to the first link about a pivot axis of the joint located between a first anchor point and a second anchor point of the second link; and first and second bi-directional actuators, each of the first and second bi-directional actuators comprising a first resilient member extending between the first anchor point and the first link and a second resilient member extending between the second anchor point and the first link, wherein the first resilient members and second resilient members have a non-linear relationship between applied force and resulting elongation, and each bi-directional actuator being controllable to increase tension in one of the first and second resilient members while decreasing tension in the other of the first and second resilient members.

Similarly, the second aspect provides a method of controlling a robotic arm comprising: a first link; a second link; a joint permitting the second link to pivot relative to the first link about a pivot axis of the joint located between a first anchor point and a second anchor point of the second link; and first and second bi-directional actuators, each of the first and second bi-directional actuators comprising a first resilient member extending between the first anchor point and the first link and a second resilient member extending between the second anchor point and the first link, wherein the first resilient members and second resilient members have a non-linear relationship between applied force and resulting elongation, the method including the steps of: controlling the first bi-directional actuator to increase tension in one of the first and second resilient members thereof while decreasing tension in the other of the first and second resilient members; and controlling the second bi-directional actuator to increase tension in one of the first and second resilient members thereof while decreasing tension in the other of the first and second resilient members.

Like the first aspect, this arrangement enables the first and second bi-directional actuators to be independently operated to enable full control of the joint. In particular, the bi-directional actuators may be operated so that they work in tandem or so that they oppose one another, or on a sliding scale therebetween to provide a range of behaviours between these extremes.

By arranging each of the resilient members between the first link and a respective anchor point on the second link it is possible to readily control movement of the second link relative to the first link. Moreover, this arrangement minimises—or even eliminates—any bending moments on the first link resulting from movement of the joint. That is, the first and second bi-directional actuators each provide tensegrity, or tensional integrity, by way of the tensioned first and second resilient members being tethered either side of the pivot axis of the joint.

A further advantage is that it is possible for each bi-directional actuator to comprise only one motor; the motor may be mounted on the first link and arranged to be capable of controlling tension in both the first resilient member and the second resilient member. In this way, the mass associated with the bi-directional actuators is located away from the joint, further improving efficiency of the joint and reducing the required motor output.

Each bi-directional actuator of the robotic arm may therefore comprise a motor (preferably a single motor) configured to control tension in both the first resilient member and the second resilient member.

In preferred embodiments the first and second bi-directional actuators are controllable to operate in a high torque mode in which the first and second bi-directional actuators each provide tension in their respective first resilient members. In this cooperating mode the bi-directional actuators work in tandem to double the available torque output; this arrangement provides a relatively low joint stiffness and a relatively high passive compliance (i.e. the joint has a relatively low resistance to deflection resulting from an externally applied torque).

The first and second bi-directional actuators are also (or alternatively) preferably controllable to operate in an antagonist mode in which the first bi-directional actuator provides tension in its first resilient member while the second bi-directional actuator provides tension in its second resilient member. In this high stiffness mode the bi-directional actuators counter-act each other by operating so that they oppose one another; this arrangement provides a relatively high joint stiffness and relatively low passive compliance (i.e. the joint has a relatively high resistance to deflection resulting from an externally applied torque). The antagonist mode may provide an overall joint stiffness from 0% (maximum passive compliance) to 100% (minimum passive compliance).

The first and second bi-directional actuators may further be controllable to operate on a sliding scale between the high torque mode and the antagonist mode. That is, in moving between the high torque mode and antagonist mode a trade-off is made between torque output and joint stiffness. For example, from the high torque mode, the first bi-directional actuator may reduce the level of tension in its first resilient member while the second bi-directional actuator gradually increases the level of tension in its second resilient member to gradually increase the overall stiffness of the joint, yet not necessarily cause the joint to move. Similarly, in the high torque mode the tension in the second resilient members of the first and/or second bi-directional actuators may also be controlled in order to provide a degree of overall joint stiffness.

This sliding scale operation results from the feature that in each of the bi-directional actuators is controllable to increase tension in one of the first and second resilient members while decreasing tension in the other of the first and second resilient members. Moreover, a tension in each of the first and second resilient members can be controlled between a minimum tension and a maximum tension; ideally, each resilient member is always under some tension.

In preferred embodiments of the first and second aspects each of the first and second bi-directional actuators comprises a continuous actuation link extending between the first anchor point and the second anchor point, the actuation link including the first resilient member and the second resilient member. The actuation link preferably comprises a flexible elongate member. It may be an assembly of a plurality of component parts including the resilient members, or single piece member in which the resilient members are integrally formed.

In this way, an increase in tension in one of the resilient members automatically results in a decrease in tension of the other of the resilient members. Moreover, each bi-directional actuator is able to comprise only one motor configured to engage the actuation link to control the relative tensions within the first and second resilient members.

In such embodiments the actuation link preferably comprises a generally non-extensible portion between the first resilient member and the second resilient member. In this way, the motor can be configured to engage (cooperate with) the non-extensible portion of the actuation link. Such an arrangement increases control accuracy by eliminating any unwanted change in tension introduced by the interaction between the actuation link and the driving motor.

In preferred embodiments of the first and second aspects each of the first and second bi-directional actuators comprises a pulley fixed to the first link, the pulley being arranged to cooperate with the actuation link such that rotation of the pulley results in an increase in tension in one of the first and second resilient members and a decrease in tension in the other of the first and second resilient members.

This arrangement provides a relatively simple way of controlling tension in the resilient members. The pulley may be a driven pulley. Each actuator may comprise a motor arranged to drive the pulley. The pulley may be arranged to cooperate with the generally non-extensible portion of the actuation link.

Any of the features of the first and second aspects may be combined with one another, either singly or in any combination. For example, the robotic arm of the first or second aspects may be used to operate the method of either of the first or second aspects. Moreover, the resilient members of the second aspect may be configured as described in relation to the first aspect, and/or the bi-directional actuators of the first aspect may be configured as described in relation to the second aspect.

Similarly, any features of the first and/or second aspects may be combined with any features of the third or fourth aspects described below. For example, the method of the third or fourth aspects may comprise a method of controlling a robotic arm according to the first and/or second aspects, or the robotic arm of the first and/or second aspect may be controlled according to the method of the third or fourth aspects. The actuator of the third or fourth aspects may comprise the first and second bi-directional actuators of the first and/or second aspect.

In general terms, the third aspect of the invention provides a passively compliant robotic arm having one or more variable stiffness joints each controllable by a variable stiffness actuator. The variable stiffness actuator can be operable in a low stiffness mode in which the joint has a relatively low resistance to deflection resulting from an externally applied torque.

In some embodiments of the third aspect the variable stiffness actuator may comprise the first and second bi-directional actuators of the first and/or second aspects of the invention, and include any of the functional or structural features of those bi-directional actuators described herein. In such embodiments the low stiffness mode may be implemented via the high torque mode (cooperating mode) of the first and/or second aspects. Similarly, the high stiffness mode may be implemented via the high stiffness mode (antagonist mode) of the first and/or second aspects.

The variable stiffness actuator may comprise first and second resilient members, an increase in tension in the first resilient member (i.e. operation in the first configuration) causing movement of the joint in a first direction and an increase in tension in the second resilient member (i.e. operation in the second configuration) causing movement of the joint in a second direction opposite to the second direction. The first and second resilient members may each have a monotonically increasing non-linear relationship between applied force and resulting elongation.

The relatively high stiffness in the high stiffness/antagonist mode results from the combined effects of the non-linear force-deflection relationship of the first and second resilient members. The resilient members may each comprise an elastic element, tendon or other resilient member that can be stretched (elongated) to increase tension therein and thereby urge the joint to move.

A third aspect of the invention provides a method of controlling a robotic arm to engage an object (e.g. grasp, grip, cut, or otherwise engage to enable an operation to be carried out thereon), the robotic arm comprising an end effector and at least one joint comprising a variable stiffness actuator having one or more resilient members actuatable to move the joint to thereby move the end effector, the variable stiffness actuator being operable in a low stiffness mode in which a resultant tension in the one or more resilient members is relatively low and a high stiffness mode in which a resultant tension in the one or more resilient members is relatively high, the method including the steps of: (a) moving the at least one joint by controlling the variable stiffness actuator in the low stiffness mode to move the end effector to a nearby location in the vicinity of the object; and subsequently (b) moving the at least one joint by controlling the variable stiffness actuator in the high stiffness mode to move the end effector to a final location in which the end effector is able to engage the object.

Similarly, the third aspect provides a robotic arm comprising: an end effector arranged to engage an object; and at least one joint comprising a variable stiffness actuator having one or more resilient members actuatable to move the joint to thereby move the end effector, the variable stiffness actuator being operable in a low stiffness mode in which a resultant tension in the one or more resilient members is relatively low and a high stiffness mode in which a resultant tension in the one or more resilient members is relatively high, wherein the variable stiffness actuator is arranged to move the end effector towards an object to be engaged initially in the low stiffness mode, and finally in the high stiffness mode.

This arrangement enables the initial movement to be performed quickly, with the low joint stiffness (high passive compliance) ensuring that impacts between the arm and an external body during this relatively high speed/low stiffness phase can be absorbed without damage to the arm or external body. Accuracy of joint position is necessarily sacrificed in the low stiffness mode as a result of the low joint stiffness, but the subsequent movement in the high stiffness mode can provide an accurate movement of the joint to thereby move the end effector to its final location.

The claimed arrangement is particularly suitable for fruit and vegetable harvesting applications. Such applications are in relatively uncontrolled environments with multiple hazards that could lead to collisions between the arm and an external body such as a person, fruit tree, bush or cane, or a support structure. Moreover, the available sensor data available in fruit- or vegetable-picking applications is necessarily incomplete or changing, since the fruit or vegetable will move or be obscured by foliage etc. In addition, there is a desire for picking to be carried out quickly. The present invention addresses all of these needs, since the initial movement in the low stiffness mode can be carried out quickly, with any collisions resulting from bad or incomplete sensor data not causing damage to the arm because of its high passive compliance in this movement phase, while the final movement in the high stiffness mode provides for an accurate final picking step.

In the low stiffness mode the variable stiffness actuator has a relatively high passive compliance, and thus provides a relatively high passive deflection of the joint in response to an externally applied torque at the joint. Similarly, in the high stiffness mode the variable stiffness actuator has a relatively low passive compliance, and thus provides a relatively low passive deflection of the joint in response to an externally applied torque at the joint.

In preferred embodiments the robotic arm comprises a plurality of joints, each joint comprising a variable stiffness actuator having one or more resilient members actuatable to move the joint to thereby move the end effector, the variable stiffness actuator being operable in a low stiffness mode in which a resultant tension in the one or more resilient members is relatively low and a high stiffness mode in which a resultant tension in the one or more resilient members is relatively high, wherein the variable stiffness actuator is arranged to move the end effector towards an object to be engaged initially in the low stiffness mode, and finally in the high stiffness mode.

In embodiments in which the variable stiffness actuator comprises first and second resilient members the relatively low resultant tension in the low stiffness mode may be provided by an arrangement in which a tension in the first resilient member is similar to a tension in the second resilient member such that their resultant tension is low. Similarly, the relatively high resultant tension in the high stiffness mode may be provided by an arrangement in which a tension in the first resilient member is significantly different to a tension in the second resilient member such that their resultant tension in relatively high.

In embodiments in which the variable stiffness actuator comprises first and second bi-directional actuators according to the first and/or second aspects, the relatively low resultant tension in the low stiffness mode may be provided by an arrangement in which a combined resultant tension in the first resilient members of the bi-directional actuators is similar to a combined resultant tension in the second resilient members of the bi-directional actuators such that their overall resultant tension is relatively low. Similarly, the relatively high resultant tension in the high stiffness mode may be provided by an arrangement in which a combined resultant tension in the first resilient members is significantly different to a combined resultant tension in the second resilient members such that their overall resultant tension is relatively high.

In preferred embodiments in step (a) the variable stiffness actuator is controlled via open loop control. Similarly, in the low stiffness mode the variable stiffness actuator is preferably controllable via open loop control.

In this way, the end effector can move relatively fast over the initial movement (the ballistic phase). Moreover, the movement can be relatively smooth, without the complex processing and in-trajectory corrections associated with closed loop control. It is also possible to vary the joint stiffness over the initial movement as a result of the open loop control; this is hard to do smoothly with closed-loop control, due to the non-linear properties of the variable stiffness actuator.

In step (b) the variable stiffness actuator is preferably controlled via closed loop feedback control. Similarly, in the high stiffness mode the variable stiffness actuator is preferably controllable via closed loop feedback control.

By providing a final approach phase in which the joint movement is controlled via closed loop feedback control, the accuracy of the approach can be maximised. Moreover, the complex processing and in-trajectory corrections associated with closed-loop control can be confined to a final approach phase in which accuracy is desirable, accuracy of joint position in the initial movement phase not being critical.

The closed loop feedback control preferably comprises controlling the variable stiffness actuator by comparing a desired joint position with a current joint position. Similarly, in the high stiffness mode the variable stiffness actuator is preferably controllable via closed loop feedback control by comparing a desired joint position with a current joint position.

In particularly preferred embodiments step (b) includes repeating the steps of: sensing a sensed location of the object; and moving the at least one joint by controlling the variable stiffness actuator in the high stiffness mode to move the end effector to the sensed location, until the end effector is at the final location. Similarly, in the high stiffness mode the variable stiffness actuator is preferably controllable by repeating the steps of: sensing a sensed location of an object to be engaged by the end effector; and moving the at least one joint by controlling the variable stiffness actuator in the high stiffness mode to move the end effector to the sensed location, until the end effector is at the final location.

This arrangement allows for errors in an initially sensed location of the object and/or changes in the position of the object to be accounted for in the final approach. In this sensor-control phase the joint position can be controlled via open loop control or closed loop control. Open loop joint control (i.e. control in which the current joint angle is not compared to the desired joint angle via a feedback loop) is preferred, since the corrections in response to the sensor data provide a de facto feedback loop.

A position of the end effector may be compared with the sensed location of the object. Similarly, control of the variable stiffness actuator may include the further step of comparing a position of the end effector with the sensed location of the object. For example, the position of the end effector relative to the sensor may be known, or the position of the end effector may be sensed by the sensor.

In preferred embodiments the sensed location is sensed by a sensor configured to move in tandem with the end effector. Similarly, the arm may comprise one or more sensors configured to move in tandem with the end effector, at least one of the one or more sensors being configured to determine the sensed location of the object.

By locating the sensor(s) so that they have a fixed relationship (position and orientation) with respect to the end effector, differences between a sensed location of an object to be picked and a current location of the end effector can be calculated in the same local coordinate system. Without such an arrangement it would be necessary to overcome errors in estimating the exact relative poses (orientation and position) of a sensor mounted elsewhere, the end-effector of the arm, and the target.

The one or more sensors preferably include a camera arranged to obtain an image of the object, and the method may include identifying the object in the image, preferably by identifying a predetermined colour or pattern in the image. Similarly, the one or more sensors preferably comprise a second sensor, preferably comprising a camera such as a colour camera, the second sensor being arranged to identify an object to be engaged by the end effector in an image captured by the second sensor, preferably by identifying a predetermined colour or pattern in the image.

Thus, image recognition techniques and/or software can be used to automatically identify target objects in an image obtained by the camera. Moreover, the identified target object can be analysed to determine whether it meets predetermined criteria. For example, in fruit-picking applications the image may be analysed to determine whether the target fruit is ripe and/or blemished, and therefore whether or not it should be picked.

The one or more sensors may include a second camera, preferably a second stereo camera, and the method may include using the second camera to obtain the sensed location of the object. Similarly, the one or more sensors may comprise a third sensor, preferably comprising a camera such as a stereo camera, the third sensor being arranged to identify the sensed location of an object to be engaged by the end effector.

A stereo camera provides an accurate position for the identified target object. When the stereo camera is mounted “in-hand”, i.e. in a fixed relationship with the end effector, then this accuracy is further increased.

Step (b) preferably comprises an initial joint control phase in which the variable stiffness actuator is controlled via closed loop control in which a current joint position is compared with a desired joint position; and a subsequent sensor control phase in which the variable stiffness actuator is controlled based on a sensed location of the object. Similarly, in the high stiffness mode the variable stiffness actuator is preferably configured to be operated initially via an initial joint control phase in which the variable stiffness actuator is controllable based on a sensed location of the object, and subsequently via a sensor control phase in which the variable stiffness actuator is controllable based on a sensed location of the object.

In this way, the inherent inaccuracies in positioning and control of variable stiffness joints can be mitigated against by using sensor data to correct the end effector position in the final approach phase. Moreover, errors in an initially sensed location of the object and/or changes in the position of the object can be accounted for in the final approach.

In step (a) the variable stiffness actuator is preferably controlled to increase the resultant tension in the one or more resilient members from the relatively low resultant tension towards the relatively high resultant tension at an end of the movement. Similarly, in the low stiffness mode the variable stiffness actuator is preferably configured to increase the resultant tension in the one or more resilient members from the relatively low resultant tension towards the relatively high resultant tension at an end of the movement.

Thus, the joint stiffness is at the relatively high level at the start of the high stiffness mode phase, and there is no requirement for a time-consuming separate interim phase in which the stiffness is increased. Moreover, it is particularly advantageous to undertake the stiffness increase during open loop control since it is hard to do smoothly under closed loop control, due to the non-linear properties of the variable stiffness actuator.

The method preferably includes the further step of, before step (a), sensing an initial estimated location of the object, and in step (a) the nearby location is in the vicinity of the initial estimated location. The further step may include using a first camera, preferably a first stereo camera, to obtain the initial estimated location of the object. Similarly, the arm may comprise a first sensor, preferably comprising a camera such as a stereo camera, arranged to sense an initial estimated location of an object, wherein the first sensor is preferably located such that it has a view of all possible positions of the end effector.

In this way, the object location data required to generate the joint movements required to achieve the desired trajectory in the initial/ballistic movement phase (step (a)) is generated. The sensor may generate a three-dimensional point cloud comprising a plurality of initial estimated locations of potential target objects. The sensor may be located so that it has a fixed position and orientation with respect to a base of the arm. Similarly, the initial estimated location(s) may be determined in a coordinate system with a reference point/origin having a fixed relationship with respect to a base of the arm.

The method may include the further steps of: grasping/gripping the object in the final location; and moving the at least one joint by controlling the variable stiffness actuator in the low stiffness mode to move the end effector along a detachment trajectory away from the final location. Similarly, the variable stiffness actuator may be arranged to move the end effector along a detachment trajectory in the low stiffness mode after the end effector has engaged an object.

This arrangement is particularly applicable to fruit- or vegetable-picking applications, in which the movement trajectory of the end effector after the fruit or vegetable has been grasped causes it to be detached from its tree, vine, cane, stem, bush or similar. By controlling the joint in the low stiffness mode in this detachment phase the movement can be carried out quickly, and with low risk of damage to the arm or its surroundings in view of the high passive compliance inherent in this mode.

In addition, the resultant tension in the one or more resilient members is preferably rapidly reduced to switch the variable stiffness actuator to the low stiffness mode. Similarly, the variable stiffness actuator is preferably arranged to rapidly reduce the resultant tension in the one or more resilient members after the end effector has grasped an object to switch the variable stiffness actuator to the low stiffness mode.

This rapid reduction in joint stiffness can provide an explosive movement of the end effector resulting from a rapid release of the pre-tensioned resilient members. Such an explosive movement may aid detachment from the fruit or vegetable from its tree, vine, cane, stem, bush or similar.

The arm may include one or more light sources arranged to illuminate an object to be engaged (e.g. grasped) by the end effector, the one or more light sources being preferably configured to move in tandem with the end effector. Similarly, the method may include illuminating the object to be engaged by the end effector, preferably using a light source configured to move in tandem with the end effector.

In this way, the quality of the visual sensor data can be maintained regardless of the environmental light conditions.

In general terms, the fourth aspect of the invention provides an arrangement by which a robotic arm can be moved to a desired location via a multi-phase movement. An end effector of the arm is moved initially to a location in the vicinity of an initial estimated location, and subsequently sensor data is used to move the end effector to a final sensed location.

In some embodiments of the fourth aspect the position of the end effector may be controlled by moving one or more joints. Movement of each of the one or more joints may be controlled by a variable stiffness actuator, such as a variable stiffness actuator comprising the first and second bi-directional actuators of the first and/or second aspects of the invention or a variable stiffness actuator according to the third aspect of the invention, and include any of the functional or structural features of those actuators described herein. In such embodiments the initial movement may be in a low stiffness mode implemented via the high torque mode (cooperating mode) of the first and/or second aspects. Similarly, the final movement may be in a high stiffness mode implemented via the high stiffness mode (antagonist mode) of the first and/or second aspects.

The fourth aspect of the invention provides a method of controlling a robotic arm to move an end effector of the robot arm to an object, the robotic arm having at least one joint that is moveable to cause movement of the end effector, the method including the steps of: sensing an initial estimated location of the object, optionally using a first sensing apparatus; moving the at least one joint to move the end effector to a nearby location in the vicinity of the initial estimated location; sensing a final sensed location of the object using a second sensing apparatus configured to move in tandem with the end effector; and moving the at least one joint to move the end effector to the final sensed location.

Similarly, the fourth aspect of the invention provides a robotic arm comprising: an end effector arranged to engage an object; at least one joint comprising an actuator actuatable to move the joint to thereby move the end effector; and a first sensing apparatus arranged to sense an initial estimated location of the object; a second sensing apparatus arranged to sense a final sensed location of the object, the second sensor being arranged to move in tandem with the end effector, wherein the actuator is arranged to move the end effector initially to the initial estimated location and finally to the final sensed location.

This arrangement enables the initial movement to be performed quickly, with both the required accuracy of end effector location after the initial movement and the required accuracy of sensor information from the first sensing apparatus being relatively low. The subsequent movement provides a final accurate movement of the joint to thereby move the end effector to its final location.

By locating the second sensing apparatus so that it has a fixed relationship (position and orientation) with respect to the end effector, differences between a sensed location of a target object and a current location of the end effector can be calculated in the same local coordinate system. Without such an arrangement it would be necessary to overcome errors in estimating the exact relative poses (orientation and position) of a sensor mounted elsewhere, the end-effector of the arm, and the target.

Moreover, by using sensor data concerning the object location to direct the movement of the joint (and thus the movement of the end effector) it is possible to keep track of moving objects, and alter the trajectory of the end effector accordingly.

The claimed arrangement is particularly suitable for fruit- and vegetable-picking applications. Such applications are in relatively uncontrolled environments where the available sensor data is necessarily incomplete or changing, since the fruit or vegetable may move or be temporarily obscured by foliage etc. In addition, there is a desire for fruit- and vegetable-picking to be carried out quickly. The present invention addresses these needs, since the initial movement can be carried out quickly based on sensor information which does not need to be particularly accurate, while the final movement provides for an accurate final picking step even when the fruit or vegetable is moving.

In preferred embodiments step (b) includes controlling movement of the joint via open loop control, preferably for at least an initial portion of a movement trajectory of the end effector towards the initial estimated location. Similarly, the actuator of the robotic arm is preferably arranged to move the end effector initially towards the initial estimated location via open loop control.

In this way, the end effector can move relatively fast over the initial movement (the ballistic phase). Moreover, the movement can be relatively smooth, without the complex processing and in-trajectory corrections associated with closed loop control. In embodiments in which joint movements are controlled by a variable stiffness actuator it is also possible to vary the joint stiffness over the initial movement as a result of the open loop control; this is hard to do smoothly with closed-loop control, due to the non-linear properties of the variable stiffness actuator.

Step (b) preferably includes controlling movement of the joint via closed loop feedback control, preferably for at least a final portion of a movement trajectory of the end effector towards the initial estimated location. Similarly, the actuator of the robotic arm is preferably arranged to move the end effector finally towards the initial estimated location via closed loop feedback control.

By providing a final approach phase to the initial estimated location in which the joint movement is controlled via closed loop feedback control, the accuracy of the approach can be maximised. Moreover, the complex processing and in-trajectory corrections associated with closed-loop control can be confined to a final approach phase in which accuracy is desirable, accuracy of joint position in the initial movement phase not being critical.

The closed loop feedback control preferably comprises controlling the actuator by comparing a desired joint position with a current joint position.

In particularly preferred embodiments the method includes repeating the further steps of: sensing a sensed location of the object using the second sensing apparatus; and moving the at least one joint to move the end effector to the sensed location, until the sensed location corresponds to the final sensed location. Similarly, the actuator is preferably controllable by repeating the steps of sensing a sensed location of the object using the second sensing apparatus; and moving the at least one joint to move the end effector to the sensed location, until the sensed location corresponds to the final sensed location.

This arrangement allows for errors in an initially sensed location of the object and/or changes in the position of the object to be accounted for in the final approach. In this sensor-control phase the joint position can be controlled via open loop control or closed loop control. Open loop joint control (i.e. control in which the current joint angle is not compared to the desired joint angle via a feedback loop) is preferred, since the corrections in response to the sensor data provide a de facto feedback loop.

A position of the end effector may be compared with the sensed location of the object. Similarly, control of the actuator may include the further step of comparing a position of the end effector with the sensed location of the object. For example, the position of the end effector relative to the sensor may be known, or the position of the end effector may be sensed by the sensor.

In step (a) using the first sensing apparatus preferably comprises using a first camera, preferably a first stereo camera, to obtain the initial estimated location of the object. Similarly, in the robotic arm the first sensing apparatus, preferably comprising a camera such as a stereo camera, is preferably located such that it has a view of all possible positions of the end effector.

In this way, the object location data required to generate the joint movements required to achieve the desired trajectory in the initial/ballistic movement phase (step (b)) is generated. The sensor(s) of the first sensing apparatus may generate a three-dimensional point cloud comprising a plurality of initial estimated locations of potential target objects. The first sensing apparatus may be located so that it has a fixed position and orientation with respect to a base of the arm. Similarly, the initial estimated location(s) may be determined in a coordinate system with a reference point/origin having a fixed relationship with respect to a base of the arm.

The method may include the further steps of: grasping/gripping the object in the final location; and moving the at least one joint by controlling the actuator to move the end effector along a detachment trajectory away from the final location. Similarly, the actuator may be arranged to move the end effector along a detachment trajectory after the end effector has grasped an object.

This arrangement is particularly applicable to fruit- or vegetable-picking applications, in which the movement trajectory of the end effector after the fruit or vegetable has been grasped causes it to be detached from its tree, vine, cane, stem, bush or similar.

In embodiments in which joint movement is controlled by a variable stiffness actuator the joint may be controlled in a low stiffness mode in this detachment phase such that the movement can be carried out quickly, and with low risk of damage to the arm or its surroundings in view of the high passive compliance inherent in this mode. In addition, in such embodiments the resultant tension in the one or more resilient members is preferably rapidly reduced to switch the variable stiffness actuator to the low stiffness mode. Similarly, wherein the variable stiffness actuator is preferably arranged to rapidly reduce the resultant tension in the one or more resilient members after the end effector has grasped an object to switch the variable stiffness actuator to the low stiffness mode. This rapid reduction in joint stiffness can provide an explosive movement of the end effector resulting from a rapid release of the pre-tensioned resilient members. Such an explosive movement may aid detachment from the fruit from its tree, vine, cane, bush or similar.

The arm may include one or more light sources arranged to illuminate an object to be engaged by the end effector, the one or more light sources being preferably configured to move in tandem with the end effector. Similarly, the method may include illuminating the object to be engaged by the end effector, preferably using a light source configured to move in tandem with the end effector.

In this way, the quality of the visual sensor data can be maintained regardless of the environmental light conditions.

In step (c) using the second sensing apparatus preferably comprises using a camera to obtain an image of the object, and identifying the object in the image, preferably by identifying a predetermined colour or pattern in the image. Similarly, in the robotic arm the second sensing apparatus, preferably comprising a camera such as a colour camera, is preferably arranged to identify an object to be engaged by the end effector in an image captured by the second sensing apparatus, preferably by identifying a predetermined colour or pattern in the image.

Thus, image recognition techniques and/or software can be used to automatically identify and track target objects in an image obtained by the camera. Moreover, the identified target object can be analysed to determine whether it meets predetermined criteria. For example, in fruit-picking applications the image may be analysed to determine whether the target fruit is ripe and/or blemished, and therefore whether or not it should be picked.

In step (c) using the second sensing apparatus preferably comprises using a second camera, preferably a second stereo camera, to obtain the final sensed location of the object. Similarly, the second sensing apparatus preferably comprises a second camera, preferably a second stereo camera, arranged to sense the final sensed location of an identified object.

A stereo camera provides an accurate position for the identified target object. When the stereo camera is mounted “in-hand”, i.e. in a fixed relationship with the end effector, then this accuracy is further increased.

In preferred embodiments the joint includes a variable stiffness actuator having one or more resilient members actuatable to move the joint to thereby move the end effector, and step (b) includes controlling the variable stiffness actuator in a low stiffness mode in which a resultant tension in the one or more resilient members is relatively low. Similarly, the joint may include a variable stiffness actuator having one or more resilient members actuatable to move the joint to thereby move the end effector, and step (d) may include controlling the variable stiffness actuator in a high stiffness mode in which a resultant tension in the one or more resilient members is relatively high.

In the low stiffness mode the variable stiffness actuator has a relatively high passive compliance, and thus provides a relatively high passive deflection of the joint in response to an externally applied torque at the joint. Similarly, in the high stiffness mode the variable stiffness actuator has a relatively low passive compliance, and thus provides a relatively low passive deflection of the joint in response to an externally applied torque at the joint.

The variable stiffness actuator may comprise first and second resilient members, an increase in tension in the first resilient member (i.e. operation in the first configuration) causing movement of the joint in a first direction and an increase in tension in the second resilient member (i.e. operation in the second configuration) causing movement of the joint in a second direction opposite to the second direction. The first and second resilient members may each have a monotonically increasing non-linear relationship between applied force and resulting elongation.

In embodiments in which the variable stiffness actuator comprises first and second resilient members the relatively low resultant tension in the low stiffness mode may be provided by an arrangement in which a tension in the first resilient member is similar to a tension in the second resilient member such that their resultant tension is low. Similarly, the relatively high resultant tension in the high stiffness mode may be provided by an arrangement in which a tension in the first resilient member is significantly different to a tension in the second resilient member such that their resultant tension in relatively high.

The relatively high stiffness in the high stiffness/antagonist mode results from the combined effects of the non-linear force-deflection relationship of the first and second resilient members. The resilient members may each comprise an elastic element, tendon or other resilient member that can be stretched (elongated) to increase tension therein and thereby urge the joint to move.

In embodiments in which the variable stiffness actuator comprises first and second bi-directional actuators according to the first and/or second aspects, the relatively low resultant tension in the low stiffness mode may be provided by an arrangement in which a combined resultant tension in the first resilient members of the bi-directional actuators is similar to a combined resultant tension in the second resilient members of the bi-directional actuators such that their overall resultant tension is relatively low. Similarly, the relatively high resultant tension in the high stiffness mode may be provided by an arrangement in which a combined resultant tension in the first resilient members is significantly different to a combined resultant tension in the second resilient members such that their overall resultant tension is relatively high.

Any features of the fourth aspect may be applied to the third aspect, and vice versa. For example, features concerning sensing of objects and consequential control of joint movement are interchangeable in these aspects. Similarly, features concerning the adjustment of joint stiffness during end effector movement are interchangeable in these aspects.

Moreover, the joints of the third and fourth aspects may be actuated by the first and second bi-directional actuators as defined in relation to the first and second aspects. The high torque mode generally corresponds to the low stiffness mode, and the antagonist mode generally corresponds to the high stiffness mode.

In a related aspect, the invention may provide a system for picking fruit or vegetables, comprising a moveable base supporting one or more robotic arms according to the first, second, third or fourth aspects. The system may comprise a cooling chamber mounted on the base for receiving fruit or vegetables picked by the one or more robotic arms.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 shows a side view of a robotic arm according to an embodiment of the invention;

FIG. 2 shows an isometric view of the robotic arm of FIG. 1;

FIG. 3 shows an embodiment of a resilient member suitable for use in embodiments of the invention;

FIGS. 4A and 4B schematically illustrate a trajectory carried out by an end effector of a robotic arm according to an embodiment of the invention, and a change in stiffness of one or more joints within that arm during movement through the trajectory, respectively;

FIGS. 5A and 5B illustrate embodiments of control architecture for a ballistic phase (FIG. 5A) and a closed-loop joint control phase (FIG. 5B) of movement of one or more joints of a robotic arm according to an embodiment of the invention; and

FIGS. 6A, 6B and 6C illustrate a fruit-picking system incorporating multiple robotic arms according to an embodiment of the invention.

### DETAILED DESCRIPTION

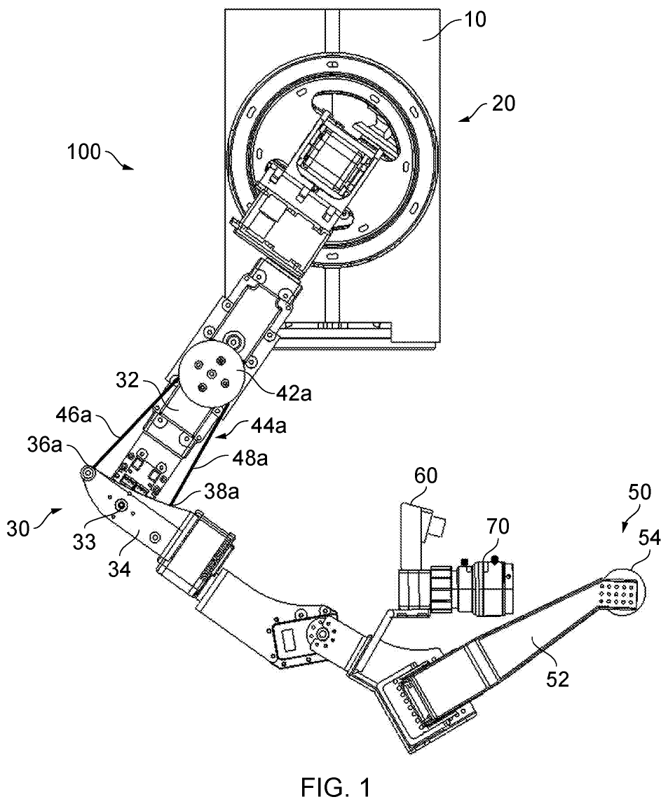

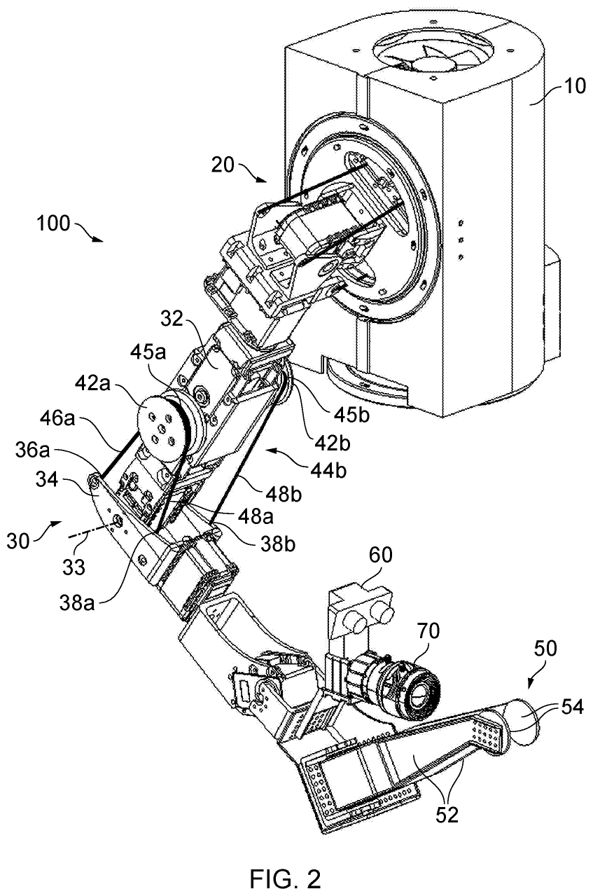

FIGS. 1 and 2 illustrate side and isometric views, respectively, of a robotic arm 100 according to an embodiment of the invention. The arm comprises a base 10 via which the arm 100 can be mounted to a structure, and via which the arm can receive an electricity supply (not shown).

The arm 100 has a plurality of articulated joints, including a shoulder joint 20 and an elbow joint 30. Each joint provides movement with six degrees of freedom; in Cartesian space this corresponds to displacement along x, y and z axes, and rotation about each of the x, y and z axes. Movement of the joints controls the position and orientation of the end effector 50, which in this embodiment comprises two opposing rigid finger members 52 with a pliable pad 54 at a free end thereof. The finger members 52 move in a pincer configuration to grip an object (not shown) between the pliable pads 54.

The shoulder joint 20 and elbow joint 30 each comprise a variable stiffness joint which enables the passive compliance of the joint (i.e. the resistance to deflection resulting from an externally applied force/torque) to be controlled. The principles of the variable stiffness joint will be described below in relation to the elbow joint 30, though the skilled reader will readily understand how these principles may be applied to the shoulder joint 20 or to any other joint in the robotic arm 100.

The elbow joint 30 is controllable to provide relative movement between a rigid first link 32 that extends towards the shoulder joint 20, and a rigid second link 34 that extends towards the end effector 50. The second link 34 pivots relative to the first link 32 about a pivot axis 33.

Relative movement between the first and second links is controlled by first 40a and second 40b bi-directional actuators that together enable the elbow joint 30 to be a variable stiffness joint. Each bi-directional actuator 40a, 40b comprises a motor (not visible in FIGS. 1 and 2) driving a pulley wheel 42a, 42b mounted on the first link 32, each of which engages a flexible actuation link 44a, 44b. The actuation links 44a, 44b each comprise an elongate cord that is tethered at one end to a first anchor point 36a, 36b on the second link 34 and at the other end to a second anchor point 38a, 38b on the second link 34, the first and second anchor points being on either side of the pivot axis 33. Each actuation link has a generally non-extensible portion 45a, 45b that engages the pulley wheel, a first tendon portion 46a, 46b (also referred to as a first resilient member 46a, 46b) that extends between the pulley wheel and the first anchor point, and a second tendon portion 48a, 48b (also referred to as a second resilient member 48a, 48b) that extends between the pulley wheel and the second anchor point.

The first 46a, 46b and second 48a, 48b tendon portions each have a monotonically increasing non-linear relationship between applied force and resulting elongation. That is, the resistance to elongation (stiffness) increases with increased applied force.

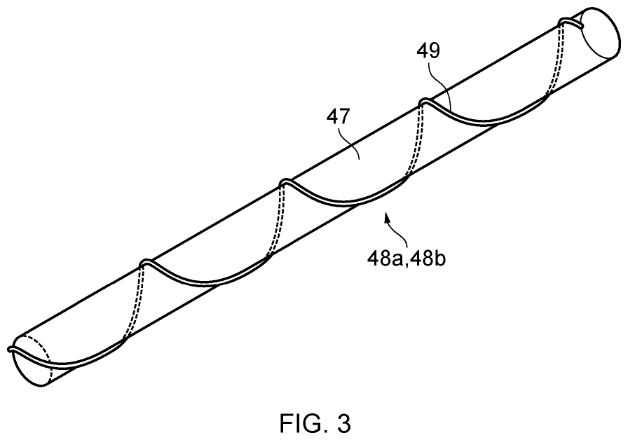

An embodiment of the first 46a, 46b and second 48a, 48b tendon portions is illustrated in FIG. 3. Each tendon portion comprises an elongate elastic core 47 around which a helical- or spiral-shaped stiffening portion 49 is wrapped. The elastic core 47 has a circular cross-section and is formed from an elastomeric material that is able to provide a significant degree of elongation (e.g. up to 700% increase in length) when under tension and return to its original shape and size when the tension is removed. An appropriate material for the elastic core 47 is a TPE thermoplastic elastomer such as Filaflex™, produced by Recreus. In contrast, the material from which the stiffening portion 49 is made is generally non-elastic; a suitable material is nylon.

When an elongating tensile force is applied to each of the tendons, the spiral shape of the stiffening portion 49 means that it becomes longer in the longitudinal direction (the direction in which the force is applied) while becoming narrower in the lateral direction (perpendicular to the longitudinal direction). This lateral contraction is resisted by the elastic core 47, and this resistance and the consequential deformation of the elastic portion causes a progressive increase in resistance to elongation with an increase in applied force. In this way, as the tendon is elongated, the elastic portion initially carries the majority of the load, but as the elongation increases the relatively stiff portion carries a progressively higher proportion of the load to provide an increasing resistance to further elongation.

In use, each bi-directional actuator 40a, 40b is able to provide movement of the elbow joint 30 in both a first direction (clockwise movement of the second link 34 relative to the first link 32, as seen in FIGS. 1 and 2) and a second direction opposite to the first direction. Movement in the first direction is caused by operating the motor to turn the pulley 42a, 42b (in the clockwise direction) to increase tension in the first tendon 46a, 46b and thereby shorten the distance between the first anchor point 36a, 36b and the pulley, while lengthening the distance between the second anchor point 38a, 38b and the pulley. Similarly, movement in the second direction is caused by operating the motor to turn the pulley 42a, 42b (in an anti-clockwise direction) to increase tension in the second tendon 48a, 48b and thereby shorten the distance between the second anchor point 38a, 38b and the pulley, while lengthening the distance between the first anchor point 36a, 36b and the pulley

In this way, each of the bi-directional actuators 40a, 40b is operable in a first configuration to urge the elbow joint 30 in the first direction, and in a second configuration to urge the joint in the second direction. By controlling movement of the joint via independent control of both the first 40a and second 40b bi-directional actuators it is possible to vary the stiffness (the resistance to externally-applied forces) of the joint while controlling its position.

That is, in a high torque mode (cooperating mode) each of the bi-directional actuators 40a, 40b may be operated to work in tandem (i.e. both in the first configuration or second configuration) to maximise the available torque output. In this mode the joint has a relatively low stiffness and relatively high passive compliance. At the other end of the spectrum, the bi-directional actuators 40a, 40b may be operated in a high stiffness mode (antagonist mode) in which they counter-act each other (i.e. one in the first configuration and the other in the second configuration). In this mode the joint has a relatively high stiffness and relatively low passive compliance.

The bi-directional actuators 40a, 40b can also be operated at any point along the continuous spectrum between the high torque mode and high stiffness mode, so that as the stiffness of the joint is reduced the available torque output can be increased, and vice versa. In this way, when low joint stiffness is required (such as during ballistic phase movements described below) the torque output of the joint can be maximised.

The relationship between the first 40a and second 40b bi-directional actuators can be described by way of the differential position, p, of the first 42a and second 42b pulleys. That is, in the high torque mode the differential position may have a maximum value of ‘1’, in the high stiffness mode a maximum value of ‘−1’, and values between ‘1’ and ‘-1’ may represent differential positions in the spectrum between these extremes.

In alternative embodiments, each of the bi-directional actuators 40a, 40b may be replaced by a uni-directional actuator (not illustrated). For example, the first uni-directional actuator 40a may comprise only the first tendon 46a and no second tendon, and the second uni-directional actuator 40b may comprise only the second tendon 48b and no first tendon. In this way, movement of the elbow joint 30 in the first direction may be achieved by operating the pulley 42a of the first uni-directional actuator 40a to increase tension in the first tendon 46a, and movement of the elbow joint 30 in the second direction may be achieved by operating the pulley 42b of the second uni-directional actuator 40b to increase tension in the second tendon 48b. Moreover, the first and second uni-directional actuators may be operated together to control the overall stiffness of the elbow joint 30 in a similar manner to that described above in relation to the high stiffness mode (antagonist mode) of the bi-directional actuator embodiment.

Each of the joints of the arm 100, including the shoulder joint 20, may have a variable stiffness joint as described above in relation to the elbow joint 30. The elbow joint 30 is described merely as being exemplary of any variable stiffness joint in the arm 100.

The robotic arm 100 also comprises a sensor-control phase stereo camera 60 and colour camera 70 mounted on an end link of the arm so that they move in tandem with the end effector. In this way, the sensor-control phase stereo camera 60 and colour camera provide continuous images of the region between the pliable pads 54 of the end effector 50, and a limited portion of the environment surrounding the end effector 50. The sensor-control stereo camera 60 and colour camera 70 are used in the sensor control (final approach) phase of movement of the robotic arm 100, as described further below.

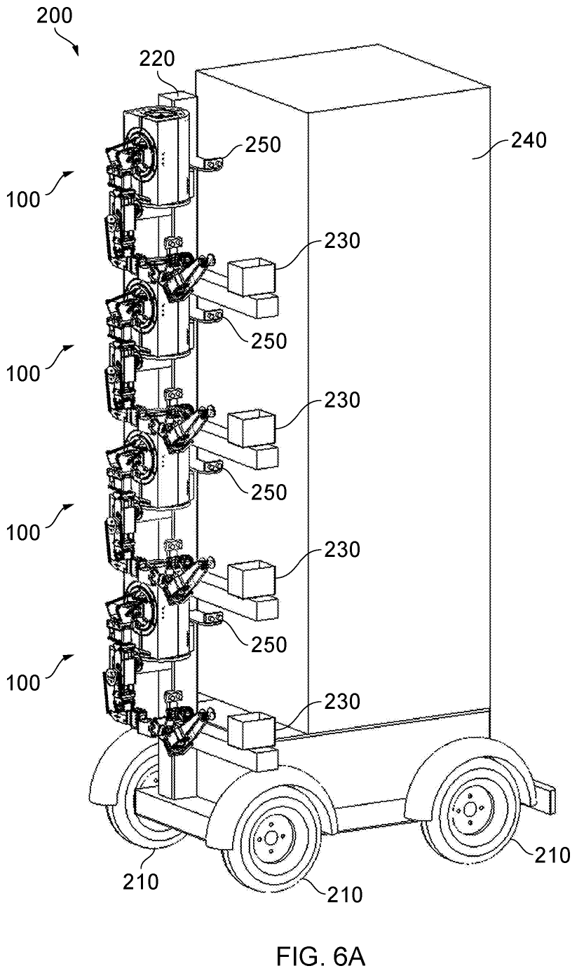

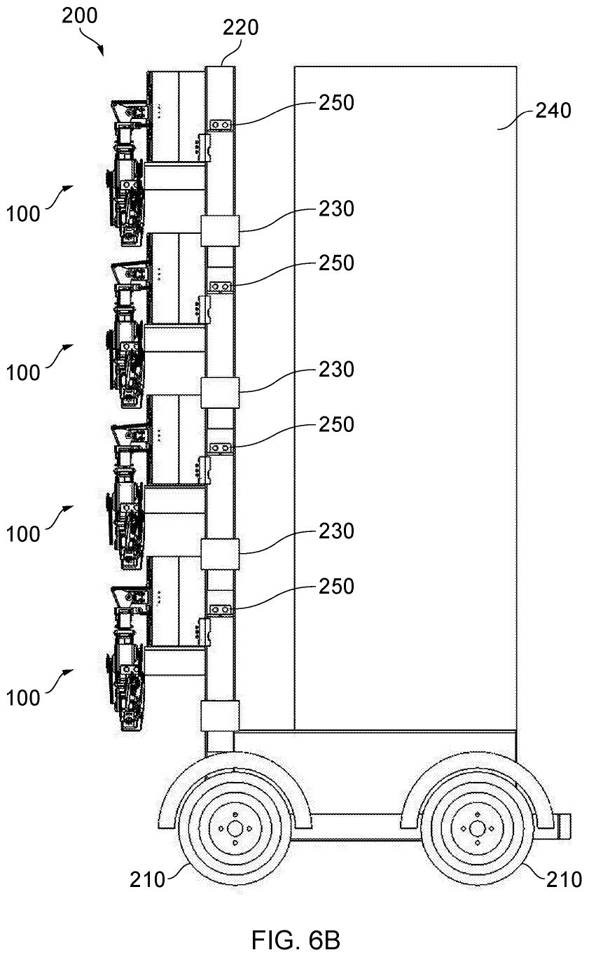

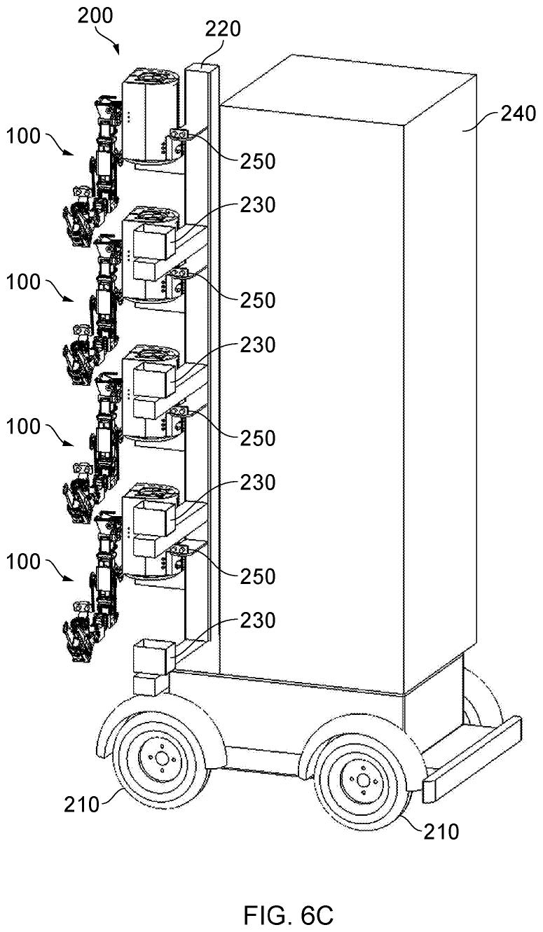

Each robotic arm 100 also has an associated joint control phase stereo camera (250 in FIGS. 6A-C; not shown in FIGS. 1 and 2) that is positioned in a fixed position with respect to the base 10, and provides images including all points accessible by the end effector 50 of that arm 100.

In use, the robotic arm 100 is controlled to control the position of the end effector 50 by controlling the position of each of the joints, including the elbow joint 30 and shoulder joint 20, while simultaneously controlling the stiffness of each of those joints.

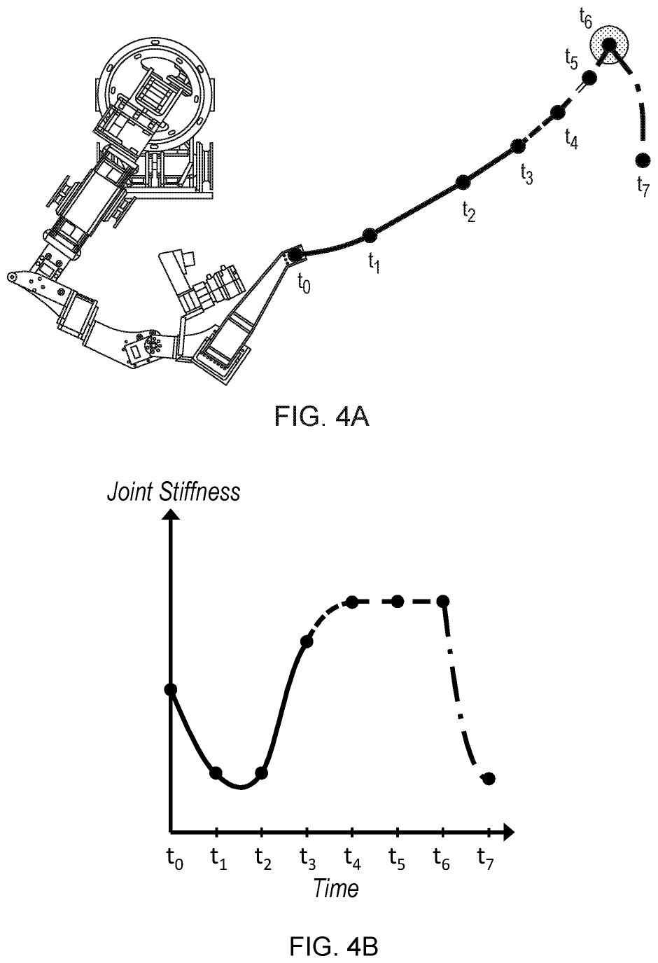

FIGS. 4A and 4B illustrate an embodiment of the invention in which the robotic arm 100 is controlled via a four-phase movement. This four-phase movement is considered to be particularly suitable for applications in which an object is to be grasped by the end effector 50, such as fruit-picking applications.

FIG. 4A illustrates an example trajectory for a fruit-picking movement, while FIG. 4B schematically illustrates the change in joint stiffness at the elbow joint 30 (or shoulder joint 20 or other joint) over that trajectory. The end effector 50 starts at t₀ and travels in a ballistic phase through t₁ and t₂ to t₃. The trajectory from t₃ to t₄ represents a closed-loop joint control phase, while the trajectory from t₄ to t₆ represents a sensor-control phase. At t₆ the end effector 50 grasps the fruit, and the trajectory from t₆ to t₇ represents the detachment phase where the fruit is detached from the stem, cane, bush, vine, stem or tree on which it has grown.

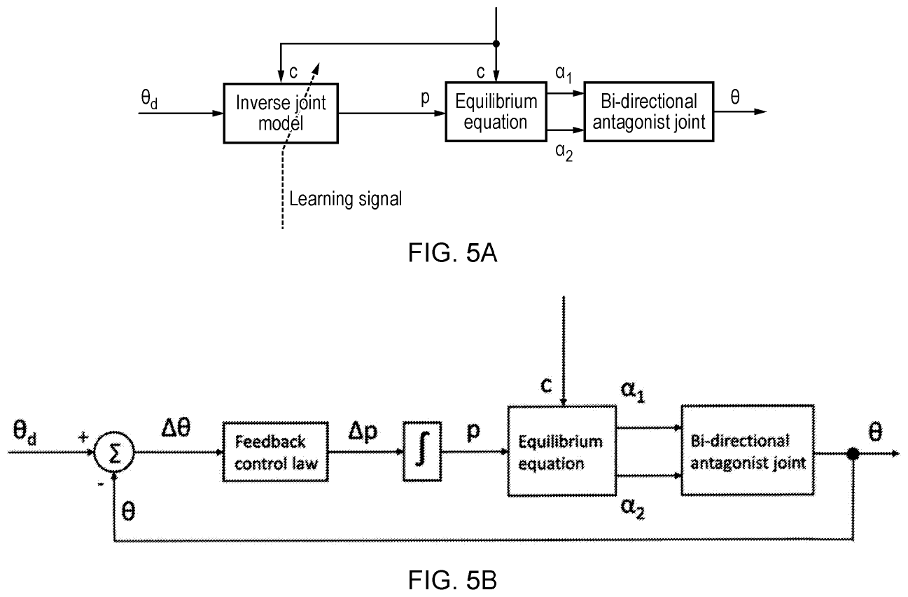

The control architecture for the ballistic phase and closed-loop joint control phase are illustrated in FIGS. 5A and 5B, respectively.

The ballistic phase (FIG. 5A) has as inputs a desired joint angle, θ_{d}, and desired joint stiffness, c. An inverse joint model is used to map the desired joint angle and desired joint stiffness to the corresponding differential position, p, of the pulleys 24a, 42b, based on the desired joint angle and desired joint stiffness. Then, an equilibrium equation is used to determine the angular position, α₁, of the pulley 42a of the first bi-directional actuator 40a and the angular position, α₂, of the pulley 42b of the second bi-directional actuator 40b that will achieve both the differential position, p, and the desired joint stiffness, c.

The output of the ballistic phase of joint control at t₃ is a joint angle, θ, which is close to θ_{d}, preferably more than 50% of θ_{d}, and ideally 60%, 70%, 80% or 85% or more of θ_{d}. The ballistic phase thus moves the end effector 50 to a nearby location in the vicinity of the initial estimated location of the fruit to be picked, as described further below.

The closed-loop joint control phase (FIG. 5B) also has as inputs the desired joint angle, θ_{d}, and desired joint stiffness, c. The current joint angle, θ, is fed back to the controller to determine a joint angle difference, Δ_{θ}, between the current joint angle, θ, and the desired joint angle, θ_{d}, and thereby reduce that difference, A. A feedback control law step determines, based on the joint angle difference, Δ_{θ}, a change in differential position, Δp, that will reduce the joint angle difference Δ_{θ}. This is then transformed into a differential position, p, which is used by an equilibrium equation to determine the angular position, α₁, of the pulley 42a of the first bi-directional actuator 40a and the angular position, α₂, of the pulley 42b of the second bi-directional actuator 40b that will achieve both the differential position, p, and the desired joint stiffness, c.

The output of the closed-loop joint control phase of joint control at t₄ is a joint angle, θ, that is even closer to θ_{d}, preferably exactly at θ_{d}. However, since the joints of the arm 100 are not rigid, but are compliant to a greater or lesser degree, achieving the desired joint angle, θ_{d}, may not result in the end effector being located in precisely in the right position to grasp the fruit. Moreover, the target may be moving (e.g. by the action of wind) and/or the location data provided by the joint control phase stereo camera may be inaccurate. The sensor-control phase corrects for these errors at the end of the trajectory, from t₄ to t₆.

Movement through the trajectory of FIG. 4A will now be described, by way of an example of how the arm is controlled in use.

At t₀ the ballistic phase stereo camera is used to generate a three-dimensional point cloud containing target positions of fruit to be picked (or other target positions in other applications). Each target has a position in a Cartesian coordinate system with an origin, or reference point, at or near the base 10 of the arm 100. Once a point of interest has been selected from the point cloud, the ballistic phase trajectory to t₃ is generated and the angular positions, α₁, of the pulley 42a of the first bi-directional actuator 40a and the angular position, α₂, of the pulley 42b of the second bi-directional actuator 40b at each of t₁, t₂ and t₃ are calculated using the control architecture described above in relation to FIG. 5A.

The joint is then moved from t₁ to t₂ and then to t₃ by controlling the bi-directional actuators 40a, 40b to reach the calculated angular positions and thereby ensure the relative positions of the pulleys 42a, 42b at each point of the ballistic phase trajectory is such that the joint has the desired joint pose with the desired level of stiffness.

It can be seen from FIG. 4B that the stiffness of the joint is relatively low during the ballistic phase, though rises from t₃ to t₄ on the approach to the closed-loop joint control phase. During this phase the joint moves relatively fast and the open loop control further speeds up arrival at t₃ by reducing the number of control steps required. This fast movement with limited control has the potential to result in collisions between the arm 100 and an external body, such as a person or structure. However, the relatively low joint stiffness ensures that the arm 100 has a relatively high level of passive compliance during the ballistic phase, with the result that such collisions should not cause damage to either the arm 100 or the external body. The high torque mode may be utilised during the ballistic phase to maximise the torque available to move the joint.

At t₃ the closed loop joint control phase commences. The control architecture described above in relation to FIG. 5B is used to calculate each change in angular position, α₁, of the pulley 42a and angular position, α₂, of the pulley 42b required to reduce the joint angle difference, Δθ. The joint is progressively moved towards t₄ by controlling the bi-directional actuators 40a, 40b to reach the calculated angular positions, and repeating until the joint angle difference, Δ_{θ}, is zero or within an allowable margin of zero.

It can be seen from FIG. 4B that the stiffness of the joint continues to rise in the closed-loop joint control phase from t₄ to t₅, to a level at which the joint stiffness is relatively high. Passive compliance in this high stiffness mode is thus reduced, but accuracy of joint position increases.

In the sensor-control phase from t₄ to t₆ the high stiffness mode is maintained. During this phase the movement of the joint is controlled based on visual data obtained by the sensor-control phase stereo camera 60 and colour camera 70. Images obtained by the colour camera 70 are analysed to identify the fruit to be picked using image recognition algorithms. For example, a cluster of pixels in a certain colour range or in a certain pattern may indicate the presence of a fruit. The image may also be analysed to determine whether the identified fruit is ripe and/or whether it is blemished, and therefore whether or not it should be picked.

Once the fruit has been identified images obtained by the approach phase stereo camera 60 are analysed to determine the sensed location of the identified fruit in a Cartesian coordinate system that is local to the end effector.

The determined sensed location is compared to the known location of the end effector 50, and the trajectory to be traveled by the end effector 50 is calculated. The angular positions of the pulleys 42a, 42b required to achieve the joint positions required to achieve movement along the calculated trajectory are determined, and the joint is moved to move the end effector to the sensed location. The sensed location may change over time as new data from the cameras 60, 70 is obtained. For example, the fruit may be moving slightly, or the accuracy of the determined location may improve as the end effector gets closer to the fruit. This process may therefore be repeated until the end effector 50 reaches a final location in which it is able to grasp the fruit.

By using sensors (stereo camera 60 and colour camera 70) that are located in a fixed position relative to the end effector (i.e. able to move in tandem with the end effector) it is possible to calculate the trajectory to be traveled by the end effector in the sensor-control phase within a local coordinate system, which reduces the processing steps required to calculate the necessary joint movements and thereby maximises the speed of motion of the end effector in the sensor-control phase.

Moreover, during the sensor-control phase the position (angle) of the joint may be controlled by open loop control or by closed loop control. Open loop control is preferred, since this will result in fewer control commands, quicker processing, and thus quicker movement of the joint.

In the detachment phase from t₆ to t₇ the end effector 50 is rapidly moved downwardly to detach the fruit. Joint movements in this phase are controlled in a similar way to the ballistic phase, via open loop control. It can be seen from FIG. 4B that the joint stiffness is rapidly decreased to a minimum stiffness level in this phase. The rapid decrease in joint stiffness may be caused by a rapid release of highly pre-tensioned tendons in the bi-directional actuators 40a, 40b. This rapid release provides an explosive release of energy at the initial part of the detachment phase, which may help to detach the fruit from its stem.

FIGS. 6A, 6B and 6C illustrate an embodiment of a fruit- or vegetable-picking system according to the invention. The system comprises a multi-arm mobile platform 200 which is movable by way of wheels 210 or alternatively by way of a rail or gantry system (not shown). The platform 200 supports four robotic arms 100 according to the first embodiment described above stacked vertically above one another, and each mounted via their base 10 to a vertical support 220 of the platform 200. Each robotic arm 100 delivers picked fruit (or vegetables) to a dedicated fruit storage container 230, such as a punnet or tray. The platform 200 also supports a cooling storage unit 240 in which the fruit storage containers 230 are placed once full, in order to maximise the shelf life of the fruit.

Each robotic arm 100 has an associated ballistic phase stereo camera 250 that provides images including all points accessible by the end effector 50 of that arm 100. Each arm 100 also includes an LED light source (not shown) mounted on the arm so as to have a fixed position relative to the end effector 50, and so as to illuminate an area encompassed by images captured by the colour camera 70 and approach phase stereo camera 60. This illumination enables fruit or vegetable picking in dark conditions, such as during the night, and also helps to control the light conditions to prevent fluctuations in data quality due to variations in the environmental light quality.

1. A robotic arm comprising:
a joint permitting movement between a first link and a second link; and
first and second bi-directional actuators, each bi-directional actuator comprising a first resilient member actuatable by an increase in tension to urge the joint to move in a first direction and a second resilient member actuatable by an increase in tension to urge the joint to move in a second direction opposite to the first direction, each of the bi-directional actuators being controllable to increase tension in one of the first and second resilient members while decreasing tension in the other of the first and second resilient members,
wherein the first resilient members and second resilient members have a monotonically increasing non-linear relationship between applied force and resulting elongation, and comprise a composite material having a generally elastic portion and a relatively stiff portion.

2. A robotic arm according to claim 1, wherein the first and second bi-directional actuators are controllable to operate in a high torque mode in which the first and second bi-directional actuators each provide tension in their respective first resilient members.

3. A robotic arm according to claim 1, wherein the first and second bi-directional actuators are controllable to operate in an antagonist mode in which the first bi-directional actuator provides tension in its first resilient member while the second bi-directional actuator provides tension in its second resilient member.

4. A robotic arm according to claim 1, wherein the relatively stiff portion provides an increase in stiffness of the respective resilient member with elongation of the resilient member.

5. A robotic arm according to claim 1, wherein the elastic portion comprises a core of the composite material and the relatively stiff portion comprises an outer surrounding portion.

6. A robotic arm according to claim 1, wherein the relatively stiff portion comprises a spiral of material encasing the elastic portion.

7. A robotic arm according to claim 1, wherein the elastic portion comprises an elastomer, such as a thermoplastic elastomer.

8. A robotic arm according to claim 1, wherein the relatively stiff portion comprises a polymer, such as a thermoplastic polymer.

9. A robotic arm according to claim 1, wherein the joint permits the second link to pivot relative to the first link about a pivot axis of the joint located between a first anchor point and a second anchor point of the second link, wherein in each of the first and second bi-directional actuators the first resilient member extends between the first anchor point and the first link and the second resilient member extends between the second anchor point and the first link.

10. A robotic arm according to claim 1, further comprising:
an end effector arranged to engage an object, movement of the joint causing movement of the end effector;
a first sensing apparatus arranged to sense an initial estimated location of the object; and
a second sensing apparatus arranged to sense a final sensed location of the object, the second sensor being arranged to move in tandem with the end effector,
wherein the first and second bi-directional actuators are arranged to move the end effector initially to the initial estimated location, preferably in the high torque mode, and finally to the final sensed location, preferably in the antagonist mode.

11. A robotic arm according to claim 3, further comprising an end effector arranged to engage an object, movement of the joint causing movement of the end effector, wherein the first and second bi-directional actuators are controllable to move the end effector towards an object to be engaged initially in the high torque mode, and finally in the antagonist mode.

12. A method of controlling a robotic arm comprising a joint permitting movement between a first link and a second link, and first and second bi-directional actuators, each of the first and second bi-directional actuators comprising a first resilient member actuatable by an increase in tension to urge the joint to move in a first direction and a second resilient member actuatable by an increase in tension to urge the joint to move in a second direction opposite to the first direction, wherein the first resilient members and second resilient members have a non-linear relationship between applied force and resulting elongation, and comprise a composite material having a generally elastic portion and a relatively stiff portion,
the method including the steps of:
controlling the first bi-directional actuator to increase tension in one of the first and second resilient members thereof while decreasing tension in the other of the first and second resilient members; and
controlling the second bi-directional actuator to increase tension in one of the first and second resilient members thereof while decreasing tension in the other of the first and second resilient members.

13. A method according to claim 12, including the step of controlling the first and second bi-directional actuators to operate in a high torque mode by increasing tension in their respective first resilient members and decreasing tension in their respective second resilient members.

14. A method according to claim 12, including the step of controlling the first and second bi-directional actuators in an antagonist mode by, in the first bi-directional actuator, increasing tension in the first resilient member and decreasing tension in the second resilient member, while simultaneously, in the second bi-directional actuator, increasing tension in the second resilient member and decreasing tension in the first resilient member.

15. A method according to claim 12, wherein the robotic arm comprises a robotic arm according to claim 1.

16. A method according to claim 12, comprising controlling the robotic arm to move an end effector of the robotic arm to an object, the method including the further steps of:
a) sensing an initial estimated location of the object using a first sensing apparatus;
b) moving the at least one joint to move the end effector to a nearby location in the vicinity of the initial estimated location, preferably by controlling the first and second bi-directional actuators to operate in the high torque mode;
c) sensing a final sensed location of the object using a second sensing apparatus configured to move in tandem with the end effector; and
d) moving the at least one joint to move the end effector to the final sensed location, preferably by controlling the first and second bi-directional actuators in the antagonist mode.

17. A method according to claim 12, comprising controlling the robotic arm to move an end effector of the robotic arm to an object, the method including controlling the first and second bi-directional actuators to move the end effector towards the object initially in the high torque mode, and finally in the antagonist mode.

18. A system for picking fruit or vegetables, comprising a moveable base supporting one or more robotic arms according to claim 1.

19-54. (canceled)

55. A method of picking fruit or vegetables comprising a method of controlling a robotic arm according to claim 16, wherein the object comprises a fruit or vegetable.

56. A method of picking fruit or vegetables comprising a method of controlling a robotic arm according to claim 17, wherein the object comprises a fruit or vegetable.
